(19) United States
(12) Patent Application Publication
(10) Pub. No.: US 2010/0328590 A1
(43) Pub. Date: Dec. 30, 2010

(54) BACK SUBSTRATE AND REFLECTIVE LIQUID CRYSTAL DISPLAY

(75) Inventor: HERB HE HUANG, SHANGHAI (CN)

Correspondence Address: J C PATENTS, 4 VENTURE, SUITE 250, IRVINE, CA, 92618, US

(73) Assignee: JIANGSU LEXVU ELECTRONICS CO., LTD., JIANGSU (CN)

(21) Appl. No.: 12/824,963

(22) Filed: Jun. 28, 2010

Related U.S. Application Data
(60) Provisional application No. 61/221,254, filed on Jun. 29, 2009.

(51) Int. Cl. G02F 1/1335

(52) U.S. Cl. 349/113

(57) ABSTRACT

A back substrate and a reflective liquid crystal display are disclosed. The back substrate comprises: a first substrate; a reflective electrode layer, formed on the first substrate, at least comprising a first reflective electrode, a second reflective electrode and a third reflective electrode which are electrically isolated; wherein the first reflective electrode is an electrode of reflecting light of a first spectrum band of incident light, the second reflective electrode is an electrode of reflecting light of a second spectrum band of the incident light, and the third reflective electrode is an electrode of reflecting light of a third spectrum band of the incident light. The structures of the back substrate and the reflective liquid crystal display are simplified, the problems associated with inter-pixel color blur and degradation of optical efficiency owing to inaccurate alignment of pixelated color filter array film and the pixelated reflective electrodes, and electrical field drop from thick dielectric color filters can be solved.

### CROSS-REFERENCE TO RELATED APPLICATIONS

This application claims priority of provisional application No. 61/221,254, filed on Jun. 29, 2009, entitled “REFLECTIVE LIQUID CRYSTAL DISPLAY PANEL”, which is incorporated herein by reference in its entirety.

### FIELD OF THE TECHNOLOGY

The present invention generally relates to liquid crystal display technologies, and more particularly, to a back substrate and a reflective liquid crystal display.

### BACKGROUND

In recent years, flat panel displays and liquid crystal displays (LCDs) in particular, enabled by the optoelectronic technology and the integrated circuits technology, have become a mainstream of display devices. An LCD has several advantageous features including, among others, thin-flat shape, lightweight, low operating voltage, low power-consumption, full colorization and low radiation. The LCD are classified into a transmission type, a reflective type and a transflective type according to their light-emitting mechanisms, wherein the reflective LCDs include liquid crystal projectors and reflective liquid crystal on silicon (LCOS).

The basic components of an LCD include a top glass substrate with a transparent conductive layer (most commonly Indium Tin Oxide, ITO), a liquid crystal cell, a back substrate with pixelated electrodes (transparent or reflective), at least one polarization film and a color filter array film. Colorization is always one of the critical technical components to LCD and all of its subsidiary classes. The most commonly used colorization scheme is based on a pixelated color filter array film placed, made of polymeric materials containing color pigments and/or dye, which requires accurately alignment with the pixelated reflective electrode matrix on the back substrate. Aligning and placing such pixelated color filter array film directly on the pixelated reflective electrodes requires complicated optical and electrical technologies. If the pixelated color filter array film can not be aligned with the pixelated reflective electrodes, such issues as inter-pixel color blur, degradation of optical efficiency will be introduced. Further more, electrical field drop from thick dielectric color filters will be introduced.

### SUMMARY

The present invention provides a back substrate and a reflective liquid crystal display to solve the problems associated with the complicated optical and electrical technologies needed for aligning and placing such pixelated color filter array film directly on the pixelated reflective electrodes, inter-pixel color blur and degradation of optical efficiency owing to inaccurate alignment of pixelated color filter array film and the pixelated reflective electrodes, and electrical field drop from thick dielectric color filters.

The present invention provides a back substrate, comprising:

a first substrate;

a reflective electrode layer, formed on the first substrate, at least comprising a first reflective electrode, a second reflective electrode and a third reflective electrode which are electrically isolated;

wherein the first reflective electrode is an electrode of reflecting light of a first spectrum band of incident light, the second reflective electrode is an electrode of reflecting light of a second spectrum band of the incident light, and the third reflective electrode is an electrode of reflecting light of a third spectrum band of the incident light.

The present invention further provides a reflective liquid crystal display, comprising a top substrate and a back substrate as mentioned before, wherein a crystal cell is sandwiched between the top substrate and the back substrate, the top substrate comprises a second substrate and a transparent conductive layer formed on the second substrate.

In the back substrate and reflective liquid crystal display provided by the present invention, the first reflective electrode, the second reflective electrode and the third reflective electrode are configured to reflect light of selected spectrum bands, with no color filters placed on the top substrate, therefore, accurate alignment of pixelated color filter array film with the pixelated reflective electrodes and complicated optical and electrical technologies are not needed. The structure of the reflective liquid crystal display is simplified, the problems that inter-pixel color blur and degradation of optical efficiency is introduced owing to inaccurate alignment of pixelated color filter array film and the pixelated reflective electrodes, and electrical field drop from thick dielectric color filters is introduced, can be solved.

### BRIEF DESCRIPTION OF THE DRAWINGS

The disclosure may be more completely understood in consideration of the following detailed description of various embodiments in connection with the accompanying drawings, in which:

FIG. 1 is a cross sectional view of one embodiment of the back substrate according to the present invention;

FIG. 2 is a cross sectional view of another embodiment of the back substrate according to the present invention;

FIG. 3 is a cross sectional view of another embodiment of the back substrate according to the present invention;

FIG. 4 is a cross sectional view of another embodiment of the back substrate according to a the present invention;

FIG. 5 is a cross sectional view of one embodiment of the reflective liquid crystal display according to the present invention;

FIG. 6 is a cross sectional view of another embodiment of the reflective liquid crystal display according to the present invention;

FIG. 7 is a cross sectional view of another embodiment of the reflective liquid crystal display according to the present invention;

FIG. 8 is a cross sectional view of another embodiment of the reflective liquid crystal display according to the present invention.

### DETAILED DESCRIPTION

The drawings for illustration are not necessarily to scale, emphasis instead being placed upon illustrating the framework and principles of the disclosed invention. In the following description, reference is made to the accompanying drawings which form a part of the specification, and which show, by way of illustration, embodiments of the present invention. It is understood that other embodiments may be utilized and structural changes may be made without departing from the scope and spirit of the present invention.

FIG. 1 is a cross sectional view of one embodiment of the back substrate according to the present invention. The back substrate includes a first substrate 200 and a reflective electrode layer 210 formed on the first substrate 200. The reflective electrode layer 210 at least includes a first reflective electrode 211, a second reflective electrode 212 and a third reflective electrode 213 which are electrically isolated. The first reflective electrode 211 is an electrode reflecting light of a first spectrum band of incident light, the second reflective electrode 212 is an electrode reflecting light of a second spectrum band of the incident light, and the third reflective electrode 213 is an electrode reflecting light of a third spectrum band of the incident light.

Cross electrical field is formed between the first reflective electrode 211, the second reflective electrode 212, the third reflective electrode 213 and a transparent conductive layer on a top substrate, which can make the liquid crystal twist to realize the display.

The first reflective electrode 211, the second reflective electrode 212 and the third reflective electrode 213 may be made from conductive inks or conductive paints comprising color additives such as pigments or dye. The conductive inks or conductive paints may further include powered silver and/or carbon. For example, Emerson & Cuming has commercialized conductive inks as the base material for defining selected spectrum band for reflection to visible light. The first reflective electrode 211, the second reflective electrode 212 and the third reflective electrode 213 made from conductive inks containing pigments or dye with different colors may reflect light of selected spectrum band.

In the back substrate provided by the first embodiment of the present invention, the first reflective electrode, the second reflective electrode and the third reflective electrode are electrodes reflecting light of selected spectrum bands, with no color filters placed on the top substrate, therefore, accurate alignment of pixelated color filter array film with the pixelated reflective electrodes and complicated optical and electrical technologies are not needed. The structure of the reflective liquid crystal display is simplified, the problems associated with inter-pixel color blur and degradation of optical efficiency owing to inaccurate alignment of pixelated color filter array film and the pixelated reflective electrodes, and electrical field drop from thick dielectric color filters can be solved.

In FIG. 1, the first reflective electrode 211, the second reflective electrode 212 and the third reflective electrode 213 reflect light of the first spectrum band, the second spectrum band and the third spectrum band, respectively. In order to obtain better display effect, the spectrum band reflected by the three reflective electrodes may be tuned. For example, the first reflective electrode 211 is an electrode reflecting red light of the incident light, the second reflective electrode 212 is an electrode reflecting green light of the incident light, and the third reflective electrode 213 is an electrode reflecting blue light of the incident light. Alternatively, the first reflective electrode 211 can be an electrode reflecting yellow light of the incident light, the second reflective electrode 212 can be an electrode reflecting magenta light of the incident light, and the third reflective electrode 213 can be an electrode reflecting cyan light of the incident light.

In FIG. 1, the back substrate may further include a transparent protective dielectric coating 205 and a first alignment layer 204 which are formed on the reflective electrode layer 210.

The reflective liquid crystal display may include a driving circuit adapted to provide electrical charge onto and discharge from the first reflective electrode 211, the second reflective electrode 212, the third reflective electrode 213 and the transparent conductive layer on the top substrate, respectively. The driving circuit may be formed either by printed circuit board, or by complementary metal oxide semiconductor (CMOS) on the first substrate 200 made from semiconductor materials.

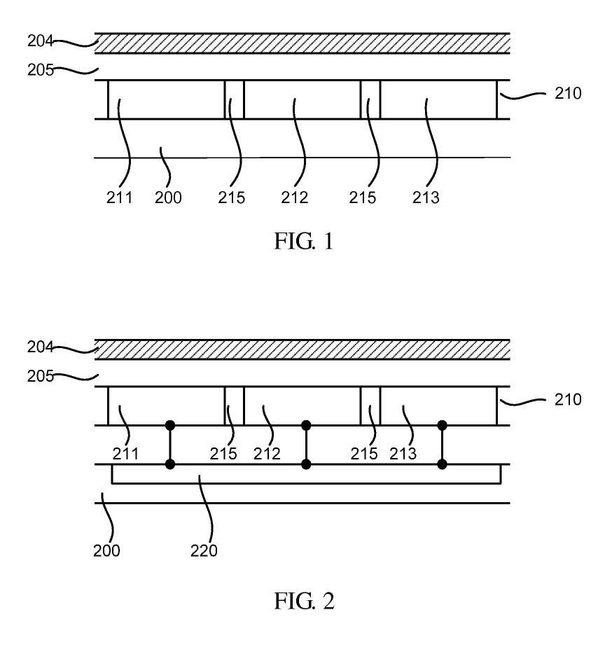

FIG. 2 is a cross sectional view of another embodiment of the back substrate according to the present invention. In this embodiment, a driving circuit 220 is formed on the first substrate 200 and under the reflective electrode layer 210. The first substrate 200 made from semiconductors such as silicon, germanium, gallium or arsenic connects with the first reflective electrode 211, the second reflective electrode 212 and the third reflective electrode 213. The driving circuit 220 may include CMOS devices, and may provide electrical charge onto and discharge from the first reflective electrode 211, the second reflective electrode 212 and the third reflective electrode 213, respectively, so as to form electrical field between the first reflective electrode 211, the second reflective electrode 212, the third reflective electrode 213 and the transparent conductive layer on the top substrate. The driving circuit 220 may be formed by LCOS on the first substrate 200. Some other layers may be formed between the driving circuit 220, the first reflective electrode 211, the second reflective electrode 212 and the third reflective electrode 213 (not shown in the FIG. 2), and the person skilled in this art can realize the structure of the FIG. 2 according to the teachings of this specification and in view of the prior LCOS technologies.

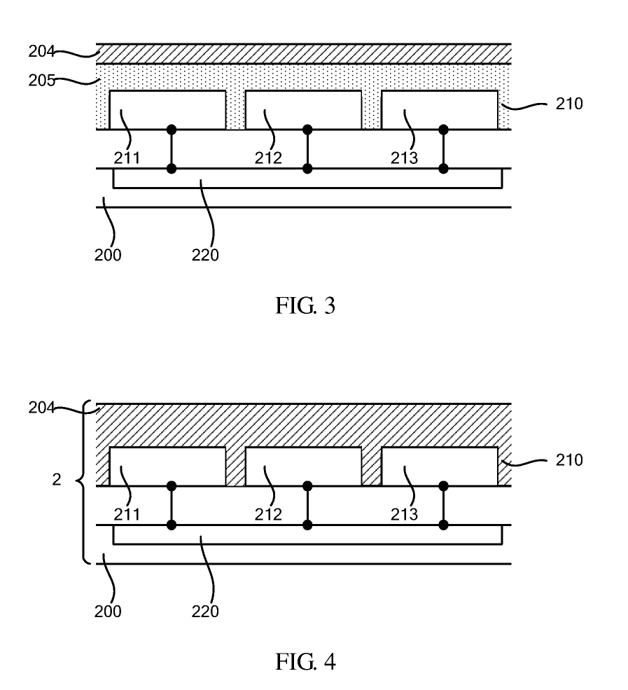

FIG. 3 is a cross sectional view of another embodiment of the back substrate according to the present invention. In this embodiment, a transparent protective dielectric coating 205 is formed on the reflective electrode layer 210, as well as between the first reflective electrode 211, the second reflective electrode 212 and the third reflective electrode 213. There is no isolator on the first substrate 200. It is the transparent protective dielectric coating 205 but not the isolator that makes the first reflective electrode 211, the second reflective electrode 212 and the third reflective electrode 213 electrically isolated from each other, which further simplifies the structure of the back substrate of LCD. The transparent protective dielectric coating 205 may protect the first reflective electrode 211, the second reflective electrode 212 and the third reflective electrode 213 from being damaged in the subsequent process, and serve as an isolator. The transparent protective dielectric coating 205 may be made from any or combination of polyimide, silicon oxide, silicon nitride and carbon, commonly available in typical silicon semiconductor manufacturing process.

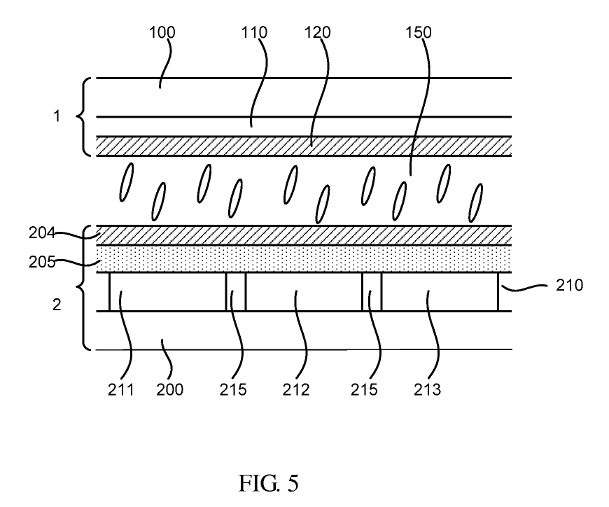

FIG. 4 is a cross sectional view of another embodiment of the back substrate according to the present invention. In this embodiment, the first alignment layer 204 is formed on and between the first reflective electrode 211, the second reflective electrode 212 and the third reflective electrode 213, without transparent protective dielectric coating 205 being formed. The first alignment layer may align the liquid crystal in the liquid crystal cell, electrically isolate the first reflective electrode 211, the second reflective electrode 212 and the third reflective electrode 213, and isolate these reflective electrodes from the liquid crystal.

In the above embodiments, the first alignment layer 204 may be made from any single or composite layer of polyimide, oxides (such as silicon oxide), nitrides (such as silicon nitride) and carbon.

The reflective liquid crystal display may include a top substrate and a back substrate in any embodiment mentioned before. FIG. 5 is a cross sectional view of one embodiment of the reflective liquid crystal display according to the present invention. In this embodiment, the reflective liquid crystal display include a top substrate 1 and a back substrate 2 as shown in the FIG. 1, with a liquid crystal cell 150 sandwiched therebetween. The top substrate 1 includes a second substrate 100 and a transparent conductive layer 110 formed on one side of the second substrate 100 facing the liquid crystal cell 150.

In the FIG. 5, a second alignment layer 120 may be formed on the transparent conductive layer 110. The second alignment layer 120 may be made from single or composite layer of polyimide, oxides (such as silicon oxide), nitrides (such as silicon nitride) and carbon, and the transparent conductive layer 110 may be made from ITO.

The first alignment layer 204 and the second alignment 120 may align the liquid crystal in the liquid crystal cell 150.

The reflective liquid crystal display may include a driving circuit adapted to provide electrical charge onto and discharge from the first reflective electrode 211, the second reflective electrode 212, the third reflective electrode 213 and the transparent conductive layer 110 on the top substrate, respectively. The driving circuit may be formed either by printed circuit board, or by complementary metal oxide semiconductor (CMOS) on the first substrate 200 made from semiconductor materials.

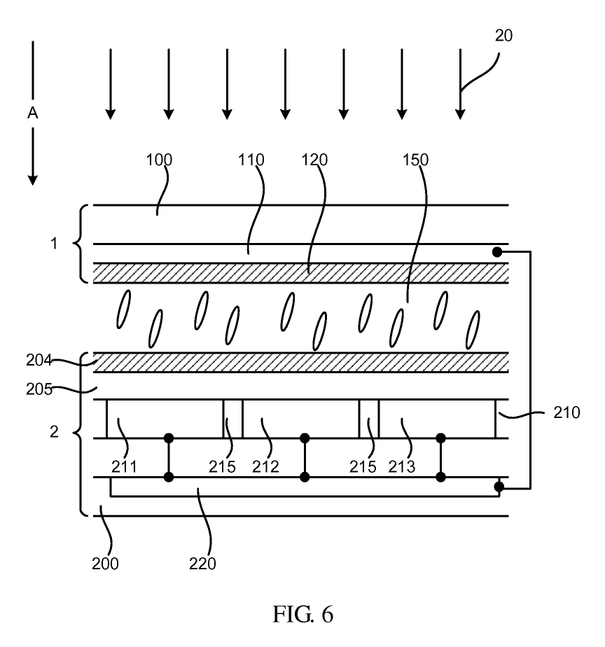

FIG. 6 is a cross sectional view of another embodiment of the reflective liquid crystal display according to the present invention. In this embodiment, the reflective liquid crystal display includes a top substrate 1 and a back substrate 2 as shown in the FIG. 2. The driving circuit 220 formed on the first substrate 200 connects with the first reflective electrode 211, the second reflective electrode 212, the third reflective electrode 213, and the transparent conductive layer 110 respectively, providing electrical charge onto and discharge from the first reflective electrode 211, the second reflective electrode 212, the third reflective electrode 213 and the transparent conductive layer 110, respectively. The principle of the reflective liquid crystal display shown in the FIG. 6 is that: when receiving the incident light 20 along the incident direction A, the first reflective electrode 211 reflects the light of the first spectrum band of the incident light 20, the second reflective electrode 212 reflects the light of the second spectrum band of the incident light 20, and the third reflective electrode 213 reflects the light of the third spectrum band of the incident light 20, which realizes a reflective-type display.

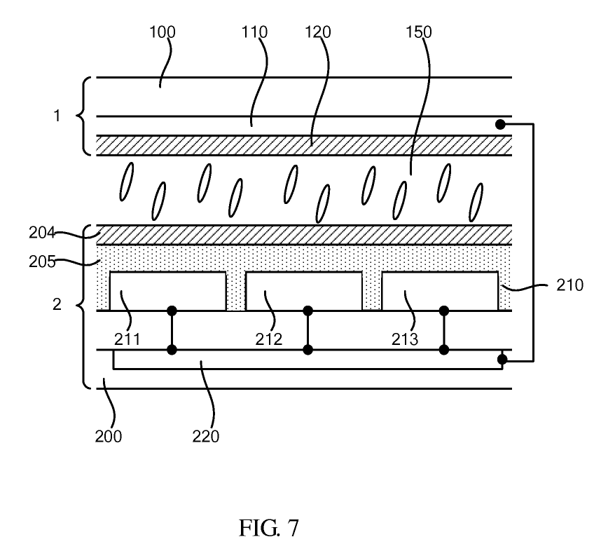

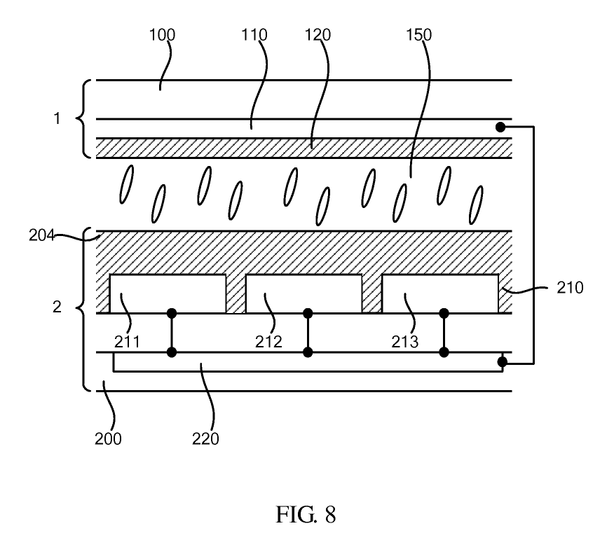

FIG. 7 is a cross sectional view of another embodiment of the reflective liquid crystal display according to the present invention. In this embodiment, the reflective liquid crystal display includes a top substrate 1 and a back substrate 2 as shown in the FIG. 3. FIG. 8 is a cross sectional view of another embodiment of the reflective liquid crystal display according to the present invention. In this embodiment, the reflective liquid crystal display includes a top substrate 1 and a back substrate 2 as shown in the FIG. 4. The principles of the reflective liquid crystal in FIGS. 7 and 8 are the same as FIG. 6. Hence no more detailed description is given here.

In the back substrate provided by the embodiments of the present invention, the first reflective electrode, the second reflective electrode and the third reflective electrode are electrodes reflecting light of selected spectrum bands, with no color filters being placed on the top substrate, therefore, accurate alignment of pixelated color filter array film with the pixelated reflective electrodes and complicated optical and electrical technologies are not needed. The structure of the reflective liquid crystal display is simplified, the problems associated with inter-pixel color blur and degradation of optical efficiency owing to inaccurate alignment of pixelated color filter array film and the pixelated reflective electrodes, and electrical field drop from thick dielectric color filters can be solved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A back substrate, comprising:
a first substrate;
a reflective electrode layer, formed on the first substrate, comprising at least a first reflective electrode, a second reflective electrode and a third reflective electrode which are electrically isolated from each other;
wherein the first reflective electrode is an electrode reflecting light of a first spectrum band of incident light, the second reflective electrode is an electrode reflecting light of a second spectrum band of the incident light, and the third reflective electrode is an electrode reflecting light of a third spectrum band of the incident light.

2. The back substrate according to claim 1, wherein the first reflective electrode, the second reflective electrode and the third reflective electrode are made from conductive inks or conductive paints comprising color additives.

3. The back substrate according to claim 2, wherein the conductive inks or conductive paints further comprises powered silver or carbon.

4. The back substrate according to claim 1, wherein the first reflective electrode is an electrode reflecting red light of the incident light, the second reflective electrode is an electrode reflecting green light of the incident light, and the third reflective electrode is an electrode reflecting blue light of the incident light.

5. The back substrate according to claim 1, wherein the first reflective electrode is an electrode reflecting yellow light of the incident light, the second reflective electrode is an electrode reflecting magenta light of the incident light, and the third reflective electrode is an electrode reflecting cyan light of the incident light.

6. The back substrate according to claim 1, wherein a first alignment layer is formed over the reflective electrode layer.

7. The back substrate according to claim 6, wherein the first alignment layer is formed between the first reflective electrode, the second reflective electrode and the third reflective electrode to electrically isolate the first reflective electrode, the second reflective electrode and the third reflective electrode.

8. The back substrate according to claim 6, wherein a transparent protective dielectric coating is formed between the first alignment layer and the reflective electrode layer, and isolators adapted to electrically isolate the first reflective electrode, the second reflective electrode and the third reflective electrode are formed between first reflective electrode, the second reflective electrode and the third reflective electrode.

9. The back substrate according to claim 6, wherein a transparent protective dielectric coating electrically isolating the first reflective electrode, the second reflective electrode and the third reflective electrode is formed between the first alignment layer and the reflective electrode layer, and is formed between the first reflective electrode, the second reflective electrode and the third reflective electrode.

10. The back substrate according to claim 6, wherein the first alignment layer is made from any single or composite layer of polyimide, oxides, nitrides and carbon.

11. The back substrate according to claims 8, wherein the transparent protective dielectric coating is made from one or combination of polyimide, silicon oxide, silicon nitride and carbon.

12. The back substrate according to claim 1, wherein the first substrate is made from semiconductors including silicon, germanium, gallium or arsenic, a driving circuit connecting with the first reflective electrode, the second reflective electrode and the third reflective electrode is formed on the first substrate, which is configured to provide electrical charge onto and discharge from the first reflective electrode, the second reflective electrode and the third reflective electrode, respectively.

13. A reflective liquid crystal display, comprising a top substrate and the back substrate according claim 1, wherein a crystal cell is sandwiched between the top substrate and the back substrate, the top substrate comprises a second substrate and a transparent conductive layer formed on the second substrate.

14. The reflective liquid crystal display according to claim 13, wherein the top substrate further comprises a second alignment layer formed on the transparent conductive layer.

15. The reflective liquid crystal display according to claim 14, wherein the second alignment layer is made from any single or composite layer of polyimide, oxides, nitrides and carbon.

16. The reflective liquid crystal display according to claim 14, wherein the transparent conductive layer is made from indium tin oxide.

17. The reflective liquid crystal display according to claim 13, wherein the transparent conductive layer connects with a driving circuit formed on the first substrate of the back substrate.
